(19) United States
(12) Patent Application Publication
(10) Pub. No.: US 2017/0072549 A1
(43) Pub. Date: Mar. 16, 2017

(54) DRIVING-IN DEVICE

(71) Applicant: Hilti Aktiengesellschaft, Schaan (LI)

(72) Inventor: Matthias BLESSING, Frastanz (AT)

(21) Appl. No.: 15/122,961

(22) PCT Filed: Mar. 24, 2015
(86) PCT No.: PCT/EP2015/056202

§ 371 Date: Sep. 1, 2016

(30) Foreign Application Priority Data
Mar. 28, 2014 (EP) 14162172.2

(51) Int. Cl. B25C 1/14; B25C 1/18

(52) U.S. Cl. CPC B25C 1/143; B25C 1/18

(57) ABSTRACT

The invention relates to a driving-in device, comprising a handheld housing, a piston element received in a piston guide for transmitting energy from a propelling charge to a securing element to be driven, and a front part which is removably connected to the piston guide. The front part and the piston guide can be moved relative to each other parallel to a central axis (A) of the piston element, and the front part is released from the piston guide by rotating the front part relative to the piston guide by a release angle, wherein a torque barrier of a securing element is overcome upon rotating by the release angle.

The invention relates to a driving-in device according to the preamble of claim 1.

From the prior art, handheld driving-in devices with propelling charges are known, wherein after the ignition of a pyrotechnical charge, the resulting combustion gases expand into a combustion chamber. As a result, a piston as the energy transfer means is accelerated and drives a fastening means into a workpiece.

In one design of such driving-in devices without automatic piston return, the piston is returned into a starting position after a driving-in process by a manual repetition movement. To this end, in a first section of the repetition movement, a piston guide is pushed forward in the driving-in direction relative to a housing until this movement is stopped by a defined stop. In a second section of the repetition movement, the piston guide is pushed together with the piston in the opposite direction rearwards into the housing, until the piston guide reaches a defined rear stop. In the course of a driving-in process, the front part of the piston guide is placed on a workpiece and is pushed in by an axial stroke up to a stop, as a result of which a triggering of the device is enabled. For the purpose of maintaining and cleaning such devices, the front part can be disassembled from the piston guide, and as a rule it is subsequently also possible to remove the piston from the piston guide.

In a previously known device, the disassembly of the front part from the piston guide is carried out as a result of the fact that the two components are moved in an axial direction into an intermediate position about halfway of the axial stroke, after which a rotation of the components relative to each other and finally an axial pulling apart have to be carried out. These movements correspond to a link-type design of a guideway provided on the piston guide. Assembly is carried out the other way round.

It is the object of the invention to provide a driving-in device that allows a simple disassembly for maintenance purposes.

For a driving-in device as mentioned in the beginning, this object is achieved according to the invention by the characterising features of claim 1. As a result of the torque barrier, the process of assembling and disassembling the front part and the piston guide are haptically improved. Moreover, an unintended release of the components can be prevented by simple means.

A central axis in terms of the invention is an axis that is at least parallel to the movement of the fastening element, which extends through a centre of the piston element.

A piston element in terms of the invention is any means by which motion energy is applied as a result of the ignition of the propelling charge, which motion energy is ultimately transferred on to the fastening means. Frequently, the piston element is implemented in particular as a cylindrical piston.

A piston guide in terms of the invention is a component in which at least a rear end of the piston element is guided. In particular, the piston guide may comprise a combustion chamber, in the region of which the propelling charge is ignited and accelerates the piston element.

A front part of the piston guide is, in terms of the invention, a component facing the workpiece, which is displaced prior to the triggering of the driving-in process in the direction of the piston guide, in particular by placing and pushing it onto the workpiece. Preferably, this releases a securing device of the driving-in device, which prevents, in case the front part is not displaced in the direction of the piston guide, an ignition of the propelling charge.

Generally advantageously, a muzzle part for receiving the fastening element is inserted into the front part, into which muzzle part a front end of the piston element can move.

A torque barrier is understood to be a resistance against rotation, which yields once a corresponding torque is exceeded. This may in particular be a latching position of an element of the securing element that is either spring-elastic or has a spring force applied thereto.

A securing element in terms of the invention is a device that prevents a release of the front part from the piston guide in the normal operating condition.

A fastening element in terms of the invention is generally understood to be any anchoring that can be driven in, such as for example a nail, a bolt or a screw.

In a generally advantageous embodiment of the invention, the securing element comprises at least one guide element which is preferably supported in a spring-elastic manner, which is provided on one of the two, the front part or the piston guide. Particularly preferably, the guide element runs here in a guideway that is provided in the respective other one of the two, front part or piston guide, and extends in parallel to the central axis. Altogether, this allows a mechanically simple and securely constructed connection of the components to be provided. In terms of a simple construction, the guideway is preferably located on the piston guide that is pushed into the front part.

In order to achieve a simple realisation of the torque barrier, a transverse way that branches off from the guideway in the circumferential direction is provided in at least one axial release position, and the transverse way has a depth that is reduced compared to the guideway, for forming the torque barrier. The guideway therefore has to overcome the reduced depth against a spring force, which requires a correspondingly enhanced torque. In a preferred detailed design of the transverse way, this may be carried out by means of a latching which may also be acoustically perceivable.

Further preferably, a disassembly way is also provided, which extends parallel to the guideway, wherein the guide element can enter from the guideway via the transverse way into the disassembly way. After entering into the disassembly way, the front part can then be pulled off from the piston guide, and to this end the disassembly way preferably opens out into an edge of the piston guide.

In a particularly preferred embodiment of the invention, the axial release position is provided near an axial end position of the guideway. This allows an intuitive and simple disassembly of the components because the operator, prior to rotating, only needs to push in or pull out the front part up to the stop relative to the piston guide. In a particularly preferred variant, it is provided here that on each of two axial end positions of the guideway, an axial release position with in each case one transverse way branching off in the circumferential direction is provided. As a result, assembly and disassembly are particularly simple and intuitive since a release is possible in any axial end position of the front part relative to the piston guide.

In order to achieve a low frictional resistance and good haptics, it is provided in a generally preferred detailed design for the guide element to be designed as a sphere. In particular, a guideway and/or a disassembly way may have a part-circular cross section corresponding to the radius of curvature of the sphere.

In a simple constructional realisation, the guide element is held in a bore by means of a spring-elastic retention ring. The bore may be dimensioned in particular in such a way that the guide element can be inserted only up to a protrusion on the other side, but cannot be pushed all the way through the bore.

Generally advantageously, the securing element does not comprise any parts that are separated during a disassembly in addition to the piston guide and the front part. As a result, any possible loss of small parts such as splint pins, snap rings or similar can be avoided.

Further advantageously, a securing element as described above may be provided multiple times, for example in the form of two guideways each with one guide element, which are offset by 180°. The guide elements may be held here in a spring-loaded manner in particular by means of a common snap ring.

Further features and advantages of the invention will result from the embodiment example as well as from the dependent claims. A preferred embodiment of the example will be described below and will be explained in more detail by means of the attached drawings, wherein:

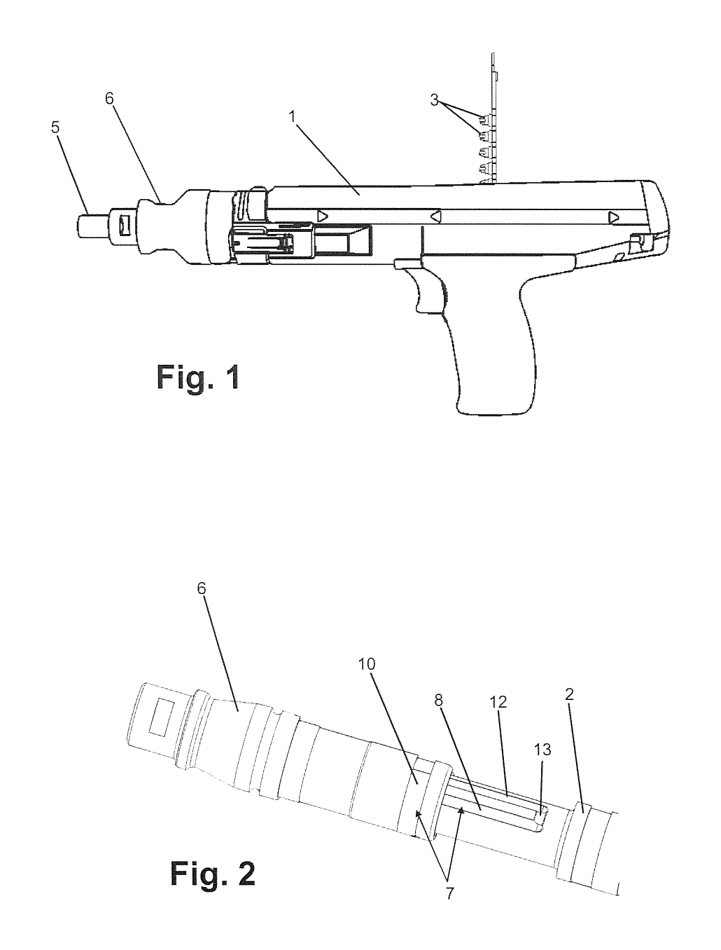

FIG. 1 shows a spatial overall view of a driving-in device according to the invention;

FIG. 2 shows a spatial view of a piston guide of the driving-in device from FIG. 1 with a front part fixed thereon in a displaceable manner;

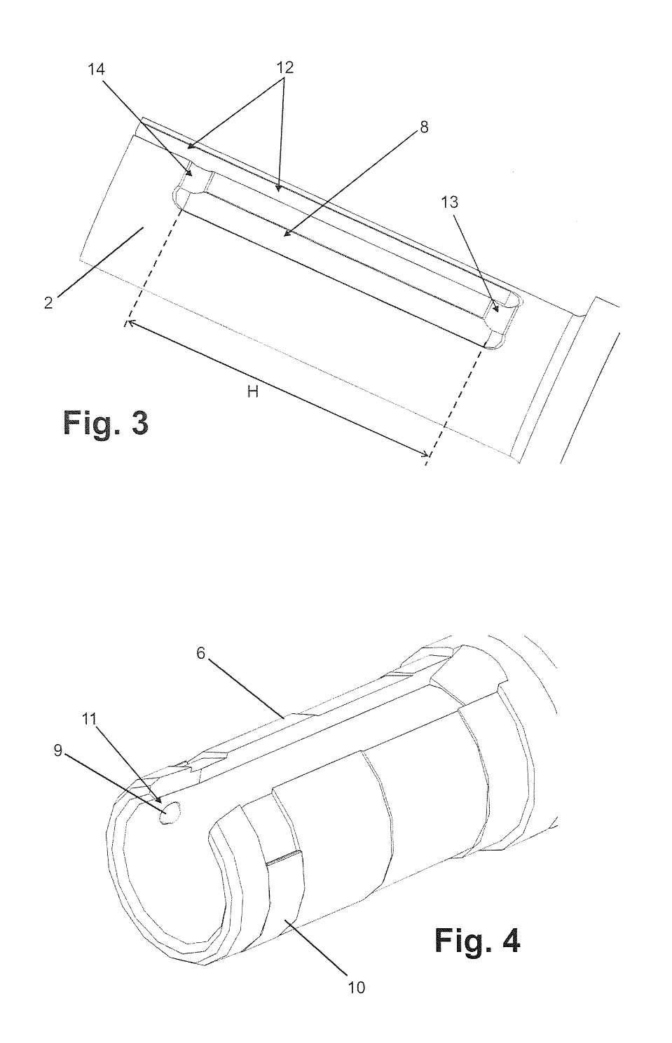

FIG. 3 shows a spatial detailed view of the piston guide from FIG. 2 with the disassembled front part;

FIG. 4 shows a spatial detailed view of the front part from FIG. 2 with a disassembled piston guide;

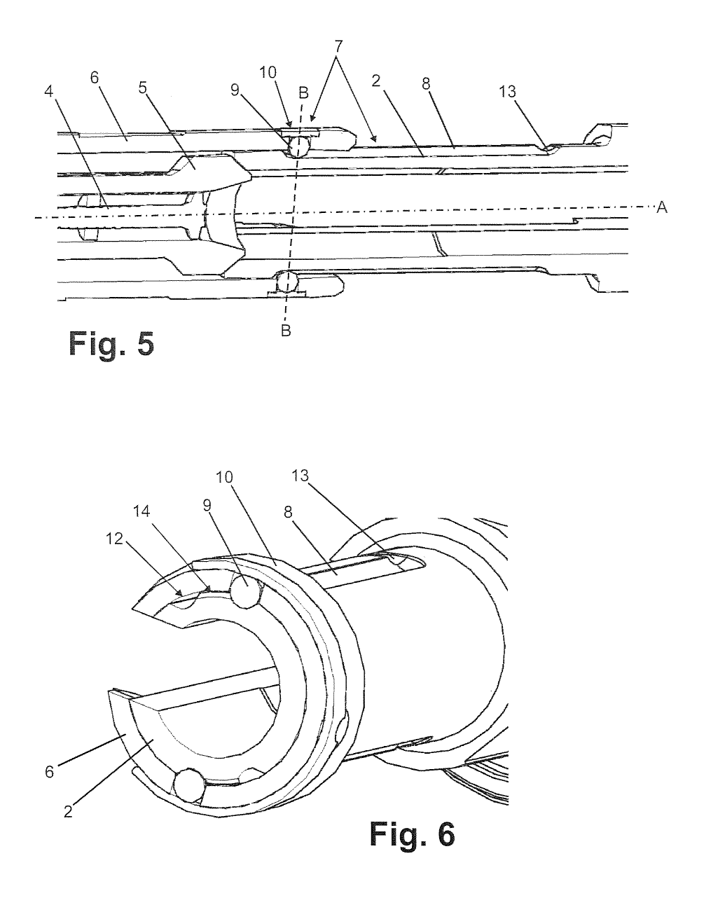

FIG. 5 shows a sectional view along a central axis A through the piston guide with a fixed front part from FIG. 2;

FIG. 6 shows a sectional view through the assembly from FIG. 5 along the line B-B.

A driving-in device according to the invention comprises a handheld housing 1, in which a piston element in the form of a piston (not shown) is received. The piston element is located in a piston guide 2 with a combustion chamber, in which the combustion gases of a pyrotechnical charge 3 expand, in order to accelerate the piston.

The piston which has motion energy applied thereto in this way impinges with an end-side plunger on a fastening element 4, which is as a result driven into a workpiece. The fastening element 4 is inserted into a muzzle part 5, which in turn is received in a front part 6 of the piston guide 2. The fastening element 4 and the muzzle part 5 are formed to be rotationally symmetrical about a central axis A. The central axis A is at the same time a central axis of the piston guide 2 and of the piston element.

The front part 6 is pushed via the piston guide 2 and is detachably fixed to the piston guide by means of a securing element 7. In this fixed condition (see FIG. 2, FIG. 5 and FIG. 6), the front part 6 and the piston guide 2 may be displaced relative to each other by a stroke H, until the displacement is terminated by a stop.

Via this stroke, during operation of the driving-in device, a securing mechanism is actuated in a known manner, which allows the charge 3 to be triggered only if the device is placed on a workpiece and the front part is pushed in with a sufficiently great pressing force by a complete stroke H.

The subject matter of the invention is presently the detachable fixing of the front part 6 on the piston guide 2. To this end, a guideway 8 is moulded onto the outside of the piston guide 2, which has a substantially part-circular cross section. The guideway 8 is engaged by a guiding element 9 in the form of a sphere made from steel. The length of the guideway 8 corresponds to the axial stroke H, and both ends of the guideway are closed.

The sphere 9 is held in a spring-elastic manner from the outside by means of a snap ring 10 in a bore 11 in the wall of the front part 6. The bore 11 has a maximum diameter that remains below the diameter of the sphere 9, so that the sphere 9 protrudes partially on the inside of the wall, but cannot fall out.

Parallel to the guideway 8, a disassembly way 12 extends, one end of which opens out into the edge of the piston guide 2.

From each of the ends of the guideway 8, in each case a transverse way 13, 14 extends in the circumferential direction up to the parallel disassembly way 12. Each of the transverse ways 13, 14 has a reduced depth compared to the disassembly way 12 and the guideway 8.

The invention works as follows:

Initially, the assembled module consisting of the front part 6 and the piston guide 2, in which the piston and the muzzle piece 5 are located, is removed from the driving-in device, and if necessary, a retention element is opened prior to that. Subsequently, the piston guide 2 and the front part 6 are disassembled from each other, in order to remove the piston and to carry out, as needed, any cleaning and maintenance works.

In the course of this, the front part is initially pulled out or pushed in up to the stop of the sphere 9 at one end of the guideway 8. Proceeding from this end position, the front part is rotated relative to the piston guide by a release angle of presently approx. 20°, and the sphere 9 extends over a corresponding transverse way 13, 14 into the disassembly way 12. In the course of this, the sphere is pushed in against the force of the snap ring via a section of movement, because the transverse way 13, 14 has a reduced depth. As a result, a torque threshold has to be exceeded during the rotation.

As soon as the sphere 9 runs in the disassembly way 12, the front part 6 can be pulled off from the piston guide 2.

The subsequent assembly process is carried out correspondingly in the opposite order.

As shown in the drawings, presently two identical securing elements 7 made up of the disassembly way 12, the guideway 8, the transverse ways 13, 14 and the sphere 9 are provided, which are arranged on the components 2, 6 offset by 180°. As a result, a particularly uniform and low-friction guiding of the front part 6 on the piston guide is ensured.

1. A driving-in device, comprising
a handheld housing,
a piston guide,
a piston element received in the piston guide for transmitting energy from a propelling charge on to a fastening element to be driven in, the piston element having a central axis (A);
a front part releasably connected to the piston guide, and
a securing element having a torque barrier,
wherein the front part and the piston guide can be moved relative to each other parallel to the central axis (A) of the piston element, and
wherein releasing the front part from the piston guide comprises a relative rotation of the front part and the piston guide about a release angle, and overcoming
the torque barrier of the securing element.

2. The driving-in device as claimed in claim 1, wherein the securing element comprises at least one guiding element supported in a spring-elastic manner, on the front part or on the piston guide.

3. The driving-in device as claimed in claim 2, wherein the guiding element runs in a guideway provided on the respective other of the front part or the piston guide, and extends in parallel to the central axis (A).

4. The driving-in device as claimed in claim 3, comprising at least one axial release position, including a transverse way branching off from the guideway in a circumferential direction, wherein the transverse way has a reduced depth compared to a depth of the guideway, forming the torque barrier.

5. The driving-in device as claimed in claim 4, further comprising a disassembly way extending in parallel to the guideway, wherein the guiding element can enter into the disassembly way from the guideway via the transverse way.

6. The driving-in device as claimed in claim 4, wherein the axial release position is located near an axial end position of the guideway.

7. The driving-in device as claimed in claim 6, wherein the guideway has two axial end positions, and each of the two axial end positions of the guideway has an axial release position with one transverse way branching off in a circumferential direction.

8. The driving-in device as claimed in claim 2, wherein the guiding element is formed as a sphere.

9. The driving device as claimed in claim 1, wherein the securing element comprises a guiding element, and the guiding element is retained in a bore by a spring-elastic retention ring.

10. The driving-in device as claimed in claim 5, wherein the axial release position is located near an axial end position of the guideway.

11. The driving-in device as claimed in claim 10, wherein the guideway has two axial end positions, and each of the two axial end positions of the guideway has an axial release position with one transverse way branching off in a circumferential direction

12. The driving-in device as claimed in claim 3, wherein the guiding element is formed as a sphere.

13. The driving-in device as claimed in claim 4, wherein the guiding element is formed as a sphere.

14. The driving-in device as claimed in claim 2, wherein the guiding element is retained in a bore by a spring-elastic retention ring.

15. The driving-in device as claimed in claim 3, wherein the guiding element is retained in a bore by a spring-elastic retention ring.

16. The driving-in device as claimed in claim 4, wherein the guiding element is retained in a bore by a spring-elastic retention ring.

17. The driving-in device as claimed in claim 5, wherein the guiding element is retained in a bore by a spring-elastic retention ring.

18. The driving-in device as claimed in claim 6, wherein the guiding element is retained in a bore by a spring-elastic retention ring.

19. The driving-in device as claimed in claim 7, wherein the guiding element is retained in a bore by a spring-elastic retention ring.

20. The driving-in device as claimed in claim 10, wherein the guiding element is retained in a bore by a spring-elastic retention ring.
